(19) United States
(12) Patent Application Publication
(10) Pub. No.: US 2021/0037801 A1
(43) Pub. Date: Feb. 11, 2021

(54) LOCKING TELESCOPIC FISHING ROD

(71) Applicant: Pure Fishing, Inc., Spirit Lake, IA (US)

(72) Inventors: Cameron Kaihara, Little Mountain, SC (US); Mark Talwin, Lexington, SC (US)

(21) Appl. No.: 16/989,300

(22) Filed: Aug. 10, 2020

Related U.S. Application Data
(60) Provisional application No. 62/884,692, filed on Aug. 9, 2019.

(51) Int. Cl. A01K 87/02; A01K 87/04

(52) U.S. Cl. CPC A01K 87/025; A01K 87/04

(57) ABSTRACT

A locking telescopic fishing rod includes a plurality of telescoping sections; a plurality of locking guide frames, one of which is secured to each rod section, each locking guide frame having a generally tubular body with a first end and a second end; the second end forming a male portion of a connection; and wherein male connection portion of a first locking guide frame for a distal rod section is configured to engage one of the inner diameter of a distal tip for an adjacent proximal rod section or the first end of a second locking guide frame, the distal tip for the adjacent proximal rod section or the first end of the second locking guide frame forming a female portion of the connection.

### CROSS REFERENCES

This application claims the priority of, and expressly incorporates by reference herein the entire disclosure of, U.S. Provisional Patent Application No. 62/884,692, filed Aug. 9, 2019.

### FIELD OF THE DISCLOSURE

The present disclosure relates to fishing rods and, more particularly, to telescopic fishing rods.

### BACKGROUND

In a telescopic fishing rod, several hollow rod sections are telescopically connected. A section having the largest outer diameter is located at the handle end of the rod and each subsequent section of the rod extending toward the distal tip gradually decreases in diameter to allow each rod section to fit within the hollow interior of the preceding rod section. Each rod section is provided with a guide frame at the distal end of the rod section. In general, prior art guide frames are of constant diameter, in particular, having an outer diameter that is larger than the outer diameter of the rod section to which it is secured as well as larger than the inner diameter of the guide frame of the immediately proximal rod section. This arrangement means that the adjacent distal guide frame serves as a hard stop against the immediately proximal guide frame preventing further insertion of the distal rod section into the proximal rod section. The above configuration results in the rod sections being unsecured in their collapsed position. This allows the sections to telescope outward when not desired in reaction to various movements.

Further, the foregoing arrangement prevents prior art telescopic fishing rods from serving another purpose: as an adjustable length pole suitable for children as they grow. Small children frequently have difficulty handling a longer rod and, as a result, experience frustration with casting. Shorter rods can ease the learning process while children are small but also limit the casting distance capability of the rod. Therefore, as the child grows and becomes more accomplished in maneuvering a rod, there is a desire for a longer rod to increase casting distance. This adds significant expense.

While prior art telescopic fishing rods are adjustable in length, that adjustability is extremely limited. More particularly, because the telescoping rod sections are only secured relative to one another when in the extended position, it is not possible to maintain only a portion of the rod sections securely in their collapsed position in order to create a secure, shorter rod.

Therefore, a need exists for a telescoping fishing rod with rod sections that may be selectively locked in a collapsed position relative to one another.

### SUMMARY

An aspect of the present disclosure is to provide a more secure telescopic fishing rod capable of secured engagement of adjacent rod sections that is also suitable for adjustment of the length of the rod.

Another aspect of the present disclosure is to provide a locking telescopic fishing rod that includes a plurality of rod sections engaged in a telescoping relationship with one another, each rod section having a proximal end closer to a handle of the fishing rod and a distal end closer to a tip of the fishing rod, the most distal rod section including the tip of the rod; a plurality of locking guide frames, one of which is secured to each rod section, each locking guide frame having a generally tubular body with a first end and a second end; the second end forming a male portion of a connection; and wherein the second end of a first locking guide frame for a distal rod section is configured to engage one of a distal tip for an adjacent proximal rod section or the first end of a second locking guide frame, the distal tip for the adjacent proximal rod section or the first end of the second locking guide frame forming a female portion of the connection.

Yet another aspect of the present disclosure is to provide a method of adjusting a length of a telescoping fishing rod having a plurality of rod sections, each rod section having a proximal end closer to a handle of the fishing rod and a distal end closer to a tip of the fishing rod, the rod sections engaged in a telescoping relationship with one another that includes the steps of providing a plurality of locking guide frames, one of which is secured to the distal end of each rod section, each locking guide frame having a generally tubular body with a first end and a second end; the second section forming a male portion of a connection; and wherein the male portion connection of a first locking guide frame of a distal rod section is configured to engage one of a distal tip of an adjacent proximal rod section or the first end of a second locking guide frame, the distal tip for the adjacent proximal rod section or the first end of the second locking guide frame further comprising a female portion of the connection; moving distal and proximal rod sections toward one another to engage the male connection portion of the first locking guide frame with the female connection portion of one of the distal tip of the adjacent proximal rod section or the first end of the second locking guide frame; and engaging the male connection portion of the first locking guide frame with the female connection portion of one of the adjacent proximal rod section or the second locking guide frame to secure the adjacent rod sections together.

Another aspect of the present disclosure is to provide a method of assembling a telescopic fishing rod having a plurality of rod sections, each rod section having a proximal end closer to a handle of the fishing rod and a distal end closer to a tip of the fishing rod, the rod sections engaged in a telescoping relationship with one another that includes the steps of providing a plurality of locking guide frames, each locking guide frame having a generally tubular body with a first end and a second end; the second end forming a male portion of a connection; and wherein the male portion connection of a first locking guide frame of a distal rod section is configured to engage one of a distal tip of an adjacent proximal rod section or the first end of a second locking guide frame, the distal tip for the adjacent proximal rod section or the first end of the second locking guide frame further comprising a female portion of the connection; securing one of the locking guide frames to each rod section with the first end of the locking guide frame secured thereto oriented closer to the distal end of the rod section than the second end of the locking guide frame.

In yet another aspect of the present disclosure, there is provided a locking guide frame for a telescopic fishing rod having a plurality of rod sections engaged in a telescoping relationship with one another, each rod section having a proximal end closer to a handle of the fishing rod and a distal end closer to a tip of the fishing rod, the locking guide frame having a generally tubular body with a first end and a second end; the second end forming a male portion of a connection; wherein one locking guide frame is secured to each rod section; and wherein the male portion connection of a first locking guide frame of a distal rod section is configured to engage one of the a distal tip of an adjacent proximal rod section or the first end of a second locking guide frame, the distal tip for the adjacent proximal rod section or the first end of the second locking guide frame further comprising a female portion of the connection.

These aspects are merely illustrative of the innumerable aspects associated with the present disclosure and should not be deemed as limiting in any manner. This and other aspects, features and advantages of the present disclosure will become apparent from the following detailed description when taken in conjunction with the referenced drawings.

### DESCRIPTION OF DRAWINGS

Reference is now made more particularly to the drawings, which illustrate one or more embodiments of the present disclosure and wherein similar reference characters indicate the same parts throughout the views.

FIG. 1 is a perspective view of a locking guide frame for a telescopic fishing rod according to one embodiment of the present disclosure.

FIG. 2 is a side view of the locking guide frame of FIG. 1.

FIG. 3 is a top view of the locking guide frame of FIG. 1.

FIG. 4 is an end view of the locking guide frame of FIG. 1.

FIG. 5 is a perspective view of a locking guide frame for a telescopic fishing rod according to another embodiment of the present disclosure.

FIG. 6 is a perspective view of a locking guide frame for a telescopic fishing rod according to another embodiment of the present disclosure.

FIG. 7 is a perspective view of another embodiment of a locking guide frame for a telescopic fishing rod according to the present disclosure.

FIG. 8 is a side view of the locking guide frame of FIG. 7.

FIG. 9 is a perspective view of a telescopic fishing rod incorporating an embodiment of a locking guide frame according to the present disclosure.

FIG. 9A is an enlarged view of a section of the telescopic fishing rod of FIG. 9.

FIG. 10 is a perspective view of a tip section of the telescopic fishing rod of FIG. 9.

FIG. 11 is a perspective view of an intermediate section of the telescopic fishing rod of FIG. 9.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

In a telescopic fishing rod, several hollow rod sections are telescopically connected, with a section with the largest outer diameter at the handle end of the rod and each subsequent section of the rod extending toward the distal tip gradually decreasing in diameter to allow each rod section to fit within the hollow interior of the preceding rod section. A telescopic guide frame 10 is secured to the distal end of each rod section. Corresponding to the decreasing diameter of the rod sections, the diameters, both inner and outer, of the telescoping guide frames 10 will progressively decrease going toward the distal, tip end of the fishing rod.

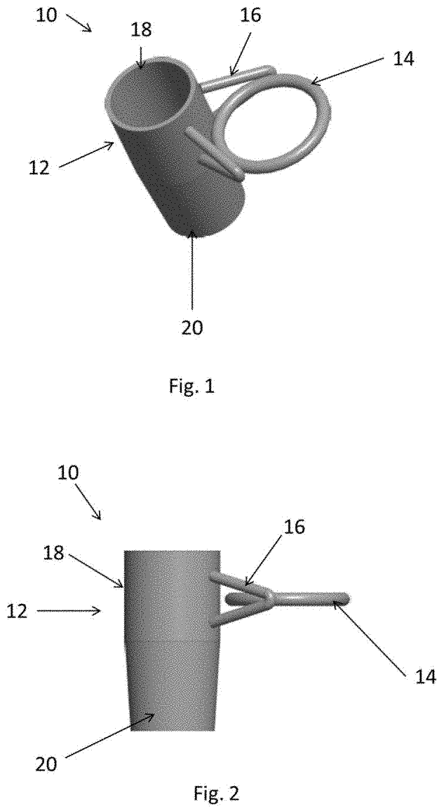

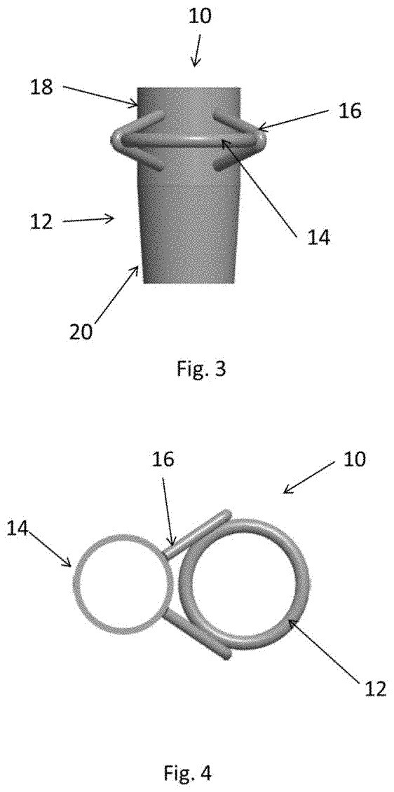

FIGS. 1-4 illustrate an embodiment of a telescopic guide frame 10 for a telescoping fishing rod. The telescopic locking guide frame 10 may include a tubular guide body 12 and line guide ring 14. Alternately, the line guide ring 14 may not be included as an integral part of the locking guide frame 10. The guide ring 14 may be brazed or welded onto the tubular guide body 12. Roughly V-shaped guide ring supports 16 may also be incorporated as the main point of connection between the tubular guide body 12 and the guide ring 14, wherein it is the guide ring supports 16 that are brazed or welded to the tubular guide body 12.

The tubular guide body 12 is provided with two sections. A first section 18 is provided with a constant diameter. A second section 20 is provided with a tapered diameter. More particularly, the outer diameter of the second section 20 is equal to that of the first section 18 at the end adjacent the first section 18 and transitions to an outer diameter less than that of the first section 18. The outer diameter of the opposite end of the second section 20 is smaller than that of the first section 18. This taper from one end to the other of the second section 20 may be smooth/continuous or stepped.

In one embodiment, the inner diameter of the tubular guide body 12 is consistent from one end to the other throughout both the first 18 and second 20 sections. In such embodiments, this may be a result of the manner of manufacture of the tubular guide body 12. More particularly, the tubular guide body 12 starts as a common piece of rigid tubing of constant outer diameter. After being cut to the desired length, one end of the tubing—subsequently becoming the second section 20—has a taper ground onto it in some embodiments, although other known means of creating a tapered circumference are also contemplated within the scope of this disclosure. However, it is considered to be within the scope of the invention if these sections are formed separately and then joined together.

As noted above, locking guide frames 10 of gradually decreasing diameter are connected to the distal end of each rod section progressing toward the tip of the rod. More particularly, the locking guide frames 10 may be connected in various manners to their respective rod sections. In one set of embodiments, the locking guide frame 10 is press fit or secured with an adhesive onto the distal tip of the rod section, wherein the guide frame is provided with an appropriate internal diameter for the desired fit with the rod section. In some embodiments, the distal tip of the rod section may extend only partially through the length of the locking guide frame 10. In others, the distal tip of the rod section may extend entirely through and up to the distal end of the locking guide frame 10 or extending beyond the distal end of the locking guide frame 10. In the latter cases, the internal diameter of the resulting assembly becomes equivalent to the internal diameter of the rod section for the purposes of the interaction with the locking guide frame 10 of a proximally adjacent rod section as discussed in more detail below. In the former case, the internal diameter of the locking guide frame 10 is the relevant dimension for that engagement.

The features of the present disclosure enable a unique interaction between the locking guide frames 10 of adjacent rod sections. More particularly the locking guide frame 10 of each adjacent rod section is sized such that the outer diameter at the end of the tapered second section 20 of the distal locking guide frame 10 is slightly smaller than the inner diameter of either the internal diameter of the adjacent proximal rod section or the the first section 18 of the proximal locking guide frame 10. This allows the proximal end of the distal locking guide frame 10 to be inserted into the interior of the adjacent proximal rod section or the first section 18 of the proximal locking guide frame 10.

The tapered nature of the distal locking guide frame 10 allows for partial insertion of the distal locking guide frame 10 into the adjacent proximal rod section or locking guide frame 10. However, while this insertion begins as a sliding fit, it gradually becomes a friction fit as the outer diameter of the distal locking guide frame 10 increases as it is inserted. The resulting friction fit between the distal locking guide frame and the adjacent proximal rod section or locking guide frame 10 effectively “locks” the two pieces together such that they will not separate from one another nor spin relative to one another unless a sufficient force is applied to the respective rod sections to pull or twist the pieces apart. In this manner, the proximal end of the distal locking guide frame 10 serves as the male portion of a connector while the inner diameter of the adjacent proximal rod section or locking guide frame 10 serves as the female portion of the connector.

The locking guide frame 10 of each rod section may be independently secured to the proximal adjacent rod section or locking guide frame 10 in the same manner. Further, two adjacent rod sections may be secured together in a collapsed position without the necessity of collapsing the remaining rod sections. This arrangement allows for the selection of a desired rod length by merely collapsing a sufficient number of rod sections to produce the desired length. In the case of a rod being used with a growing child, fewer than all of the rod sections may be collapsed to produce a shorter rod that is easier for the child to handle. as Additional rod sections may be extended as the child grows in size and ability to handle and control a longer rod.

This arrangement also enhances complete collapsing of all of the rod sections for travel. In particular, the locking arrangement of the adjacent locking guide frames 10 secures the rod sections in their fully collapsed position for travel and prevents the rod sections from prematurely extending in response to jostling, mishandling, or normal movement during travel.

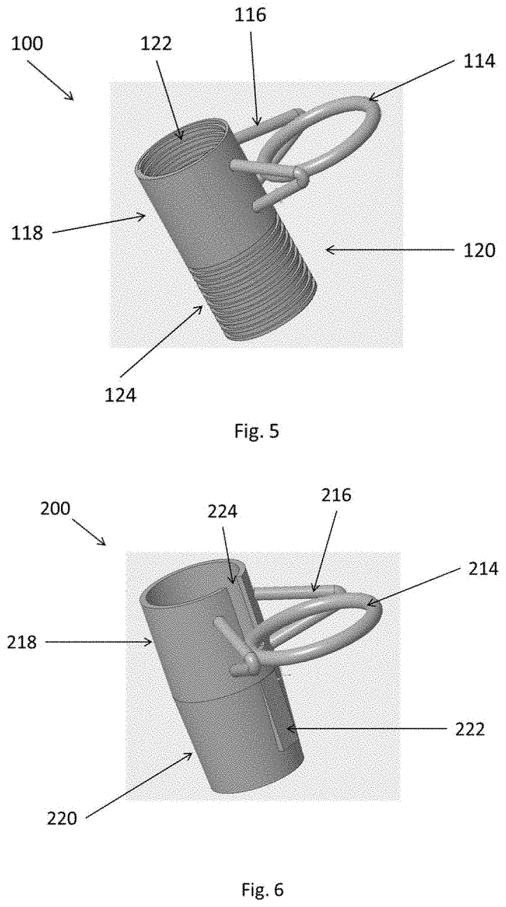

In an alternate embodiment illustrated in FIG. 5, a locking guide frame 100 may be provided with a second section 120 that is provided with a male threaded portion 122. Correspondingly, the first section 118 of the locking guide frame 100—or the associated distal tip of the adjacent proximal rod section—may be provided with a female threaded portion 124 in its inner diameter. The male 122 and female 124 threaded portions would preferably be sized to allow the male threaded portion 122 of a distal locking guide frame 100 to be threaded into the female threaded portion 124 of the adjacent proximal locking guide frame 100 or rod section in order to secure two adjacent rod sections together. This embodiment would function essentially as described above.

In another embodiment illustrated in FIG. 6, the locking guide frame 200 may be provided with a male key protrusion 222 or a female key recess or slot 224. In the illustrated embodiment, a male key protrusion 222 is provided on the exterior surface of the second section 220, while a female key recess or slot 224 is provided on the exterior surface of the first section 218. However, the positioning of these elements may be reversed. Further the mating structure, female recess/slot or male key protrusion, may be provided in the rod section itself. In certain versions of this embodiment, the distal tip of the associated rod section may not extend entirely through the locking guide frame 200 and instead extend therethrough only up to the beginning of the female key recess or slot 224. In the preferred embodiment, the male 222 and female 224 components are aligned with one another parallel to the axis of the guide frame 200. Further, these components 222, 224 are aligned with the guide ring 214. This embodiment is particularly effective at ensuring appropriate alignment of the various guide rings 214 of the telescopic rod.

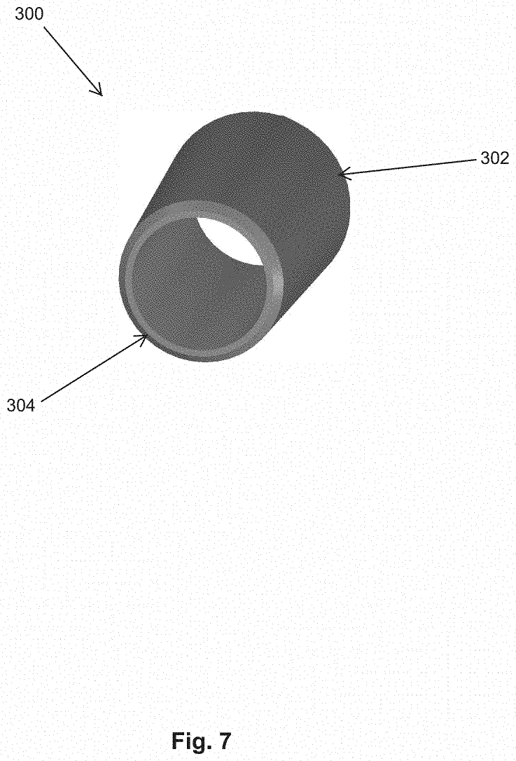

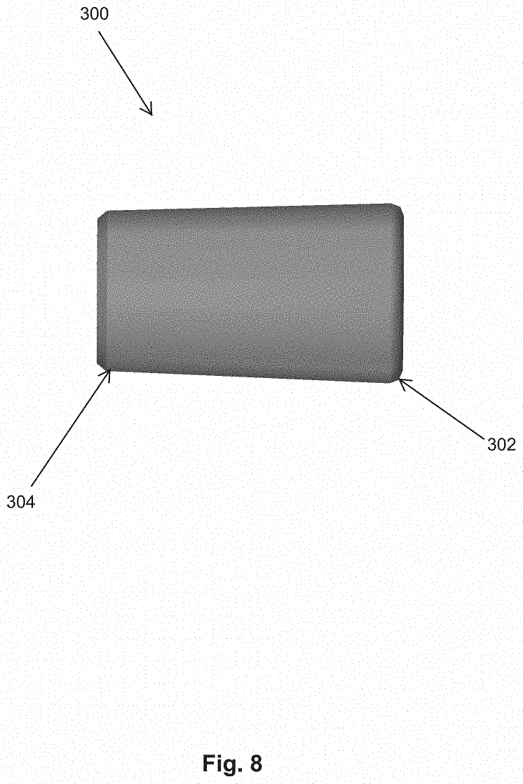

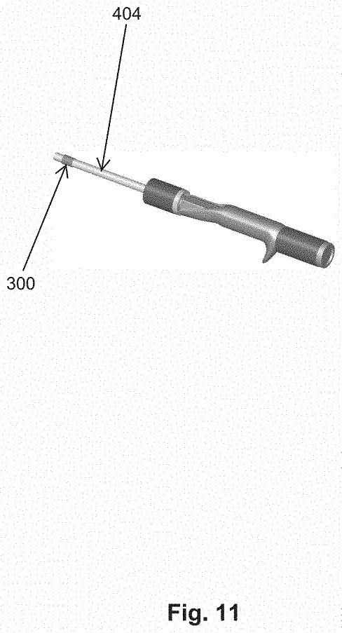

FIGS. 7-11 illustrate yet another embodiment of a locking guide frame 300 in which structures generally corresponding to the first 18 and second 20 sections of the above described embodiments are separate structures. The first structure, which may be referred to as line guide frame 310, corresponds to the first section 18 and may be provided with a consistent diameter and a line guide ring 312 attached thereto. The second section forms the locking guide frame 300 and may be tapered from its first end 302 to its second end 304 such that the outer diameter of the second end 304 is less than that of the first end 302. This taper may be smooth/continuous or stepped. As in other embodiments disclosed herein, the inner diameter of the locking guide frame 300 may be consistent from one end to the other. The line guide frame 310 and locking guide frame 300 may be immediately adjacent to one another or separated by a distance. Separation of the two sections 18, 20 of the previously described locking guide frame 10 provide a benefit in a simplified manufacturing process.

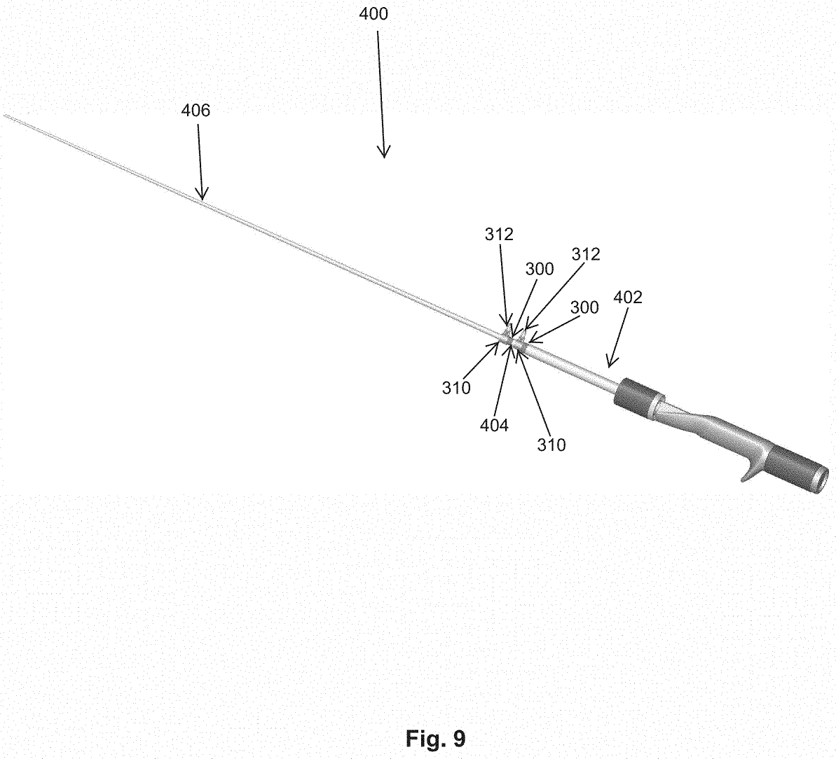

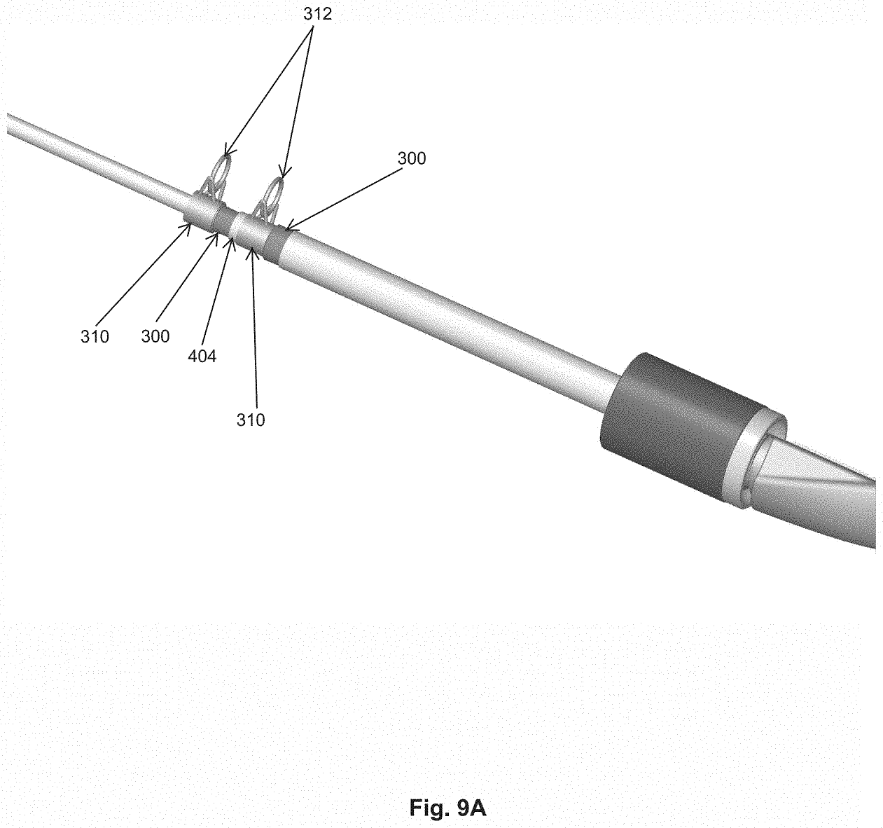

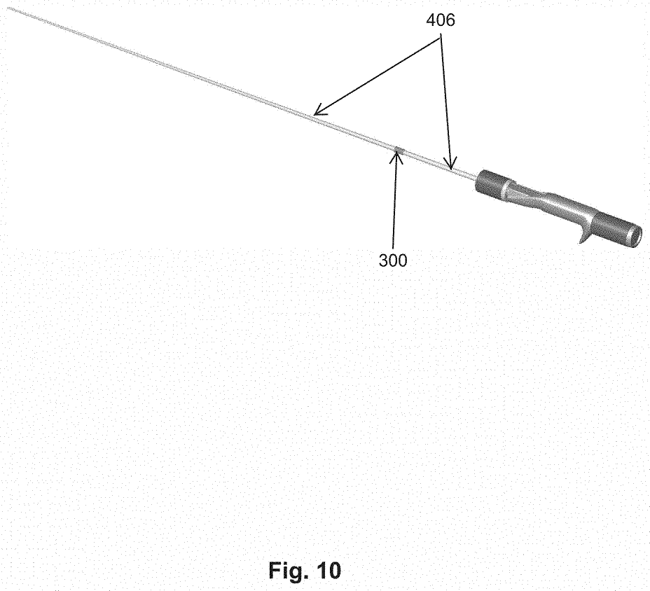

Locking guide frames 300 of gradually decreasing diameter are connected to the distal end of each rod section progressing toward the tip of the rod. More particularly, the locking guide frames 300 may be connected with their respective rod sections as described elsewhere herein. In some embodiments, the locking guide frames 300 may be formed integrally with the associated rod section. The line guide frames 310 and locking guide frames 300 may be positioned slightly proximal to the distal end of their associated rod sections, i.e., so that a portion of the rod section is visible on the distal side of the components as shown in FIGS. 9-11.

The locking guide frame 300 of each adjacent rod section is sized such that the outer diameter at the second end 304 of the distal guide frame 300 is slightly smaller than the inner diameter of the proximal rod section, which allows the second end 304 to be inserted into the interior of the distal end of the proximal rod section. In alternate embodiments, the outer diameter at the second end 304 of the distal locking guide frame 300 is slightly smaller than the inner diameter of the first end 302 of the proximal locking guide frame 300, allowing the second end 304 to be inserted into the interior of the first end 302 of the proximal locking guide frame 300. However, the outer diameter of the first end 302 of the distal locking guide frame 300 is larger than the inner diameter of the adjacent proximal rod section—or proximal locking guide frame 300. This limits the amount of travel of the distal guide frame 300 into the adjacent proximal rod section or proximal locking guide frame 300.

As described above, the locking guide frame 300 and adjacent proximal rod section or proximal line guide frame may be provided with male and female threaded structures or key/slot structures rather than a tapered structure.

FIGS. 9-11 illustrate a different rod section arrangement that may be used with various embodiments of the locking guide frames described herein. More particularly, a rod 400 may be provided with three rod sections: a base section 402, an intermediate section 404, and a tip section 406. In the illustrated arrangement, the tip section 406 is substantially longer than the intermediate 404 or base 402 sections. In the rod's collapsed state, the tip section 406, therefore, extends significantly outwardly from the other sections. In this arrangement, the locking guide frame (e.g., 10, 100, 200, or 300) for the tip section 406 is positioned intermediate the two ends of the tip section 406, rather than adjacent to the distal/tip end, as shown in FIG. 10.

The arrangement of FIGS. 9-11 also illustrate possible alternative positioning of the guide frames relative to the distal ends of each rod section. More particularly, the guide frame for each rod section may be connected with the rod section at a point slightly away from the distal end of the rod section.

The preferred embodiments of the present disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. A locking telescopic fishing rod, comprising:
a plurality of rod sections engaged in a telescoping relationship with one another, each rod section having a proximal end closer to a handle of the fishing rod and a distal end closer to a tip of the fishing rod, the most distal rod section including the tip of the rod;
a plurality of locking guide frames, one of which is secured to each rod section, each locking guide frame further comprising:
a generally tubular body with a first end and a second end;
the second end forming a male portion of a connection; and
wherein the second end of a first locking guide frame for a distal rod section is configured to engage one of a distal tip for an adjacent proximal rod section or the first end of a second locking guide frame, the distal tip for the adjacent proximal rod section or the first end of the second locking guide frame forming a female portion of the connection.

2. The locking telescopic fishing rod as set forth in claim 1, further comprising a line guide ring affixed to at least one of the rod sections or to at least one of the locking guide frames.

3. The locking telescopic fishing rod as set forth in claim 1, wherein an exterior of the generally tubular body includes a tapered outer surface at the second end.

4. The locking telescopic fishing rod as set forth in claim 2, further comprising a line guide frame associated with each locking guide frame.

5. The locking telescopic fishing rod as set forth in claim 4, wherein the line guide frame and locking guide frame are integral with one another.

6. The locking telescopic fishing rod as set forth in claim 4, wherein the line guide frame and locking guide frame are separate components.

7. The locking telescopic fishing rod as set forth in claim 1, wherein at least a portion of the generally tubular body is tapered in a direction from the first end to the second end.

8. The locking telescopic fishing rod as set forth in claim 1, wherein an exterior of the second end of each locking guide frame includes a male threaded section and wherein one of the distal tip of the adjacent proximal rod section or the first end of the second locking guide frame further comprises a female threaded section.

9. The locking telescopic fishing rod as set forth in claim 1, wherein the second end of each locking guide frame includes a male key protrusion and wherein one of the distal tip of the adjacent proximal rod section or the first end of the second locking guide frame includes a female key recess or slot.

10. A method of adjusting a length of a telescoping fishing rod having a plurality of rod sections, each rod section having a proximal end closer to a handle of the fishing rod and a distal end closer to a tip of the fishing rod, the rod sections engaged in a telescoping relationship with one another, comprising the steps of:
providing a plurality of locking guide frames, one of which is secured to the distal end of each rod section, each locking guide frame further comprising;
a generally tubular body with a first end and a second end;
the second section forming a male portion of a connection; and
wherein the male portion connection of a first locking guide frame of a distal rod section is configured to engage one of a distal tip of an adjacent proximal rod section or the first end of a second locking guide frame, the distal tip for the adjacent proximal rod section or the first end of the second locking guide frame further comprising a female portion of the connection;
moving distal and proximal rod sections toward one another to engage the male connection portion of the first locking guide frame with the female connection portion of one of the distal tip of the adjacent proximal rod section or the first end of the second locking guide frame; and
engaging the male connection portion of the first locking guide frame with the female connection portion of one of the adjacent proximal rod section or the second locking guide frame to secure the adjacent rod sections together.

11. The method of adjusting a length of a telescoping fishing rod as set forth in claim 10, wherein:
the step of providing a plurality of locking guide frames further comprises providing the generally tubular body with a tapered outer surface; and
wherein the step of engaging the male connection portion of the first locking guide frame with the female connection portion of one of the adjacent proximal rod section or the second locking guide frame further comprises inserting the tapered outer surface of the first locking guide frame into one of the distal tip of the adjacent proximal locking guide frame or the first end of the second locking guide frame until the tapered outer surface of the first locking guide frame engages an interior surface of the distal tip of the adjacent proximal locking guide frame or the first end of the second locking guide frame.

12. The method of adjusting a length of a telescoping fishing rod as set forth in claim 10, wherein the step of providing a plurality of locking guide frames further comprises providing a plurality of line guide frames adjacent to the locking guide frames and providing a plurality of line guide frames further comprises providing line guide frames and locking guide frames that are integral with one another.

13. The method of adjusting a length of a telescoping fishing rod as set forth in claim 12, wherein each locking guide frame and adjacent line guide frame are integral with one another.

14. The method of adjusting a length of a telescoping fishing rod as set forth in claim 12, wherein each locking guide frame and adjacent line guide frame are separate components.

15. The method of adjusting a length of a telescoping fishing rod as set forth in claim 10, wherein:
the step of providing a plurality of locking guide frames further comprises providing the second end of each locking guide frame with a male threaded section and an interior of the first end of each locking guide frame with a female threaded section; and
wherein the step of engaging the male connection portion of the first locking guide frame with the female connection portion further comprises rotating one or both of the adjacent rod sections relative to the other to engage the male threaded section with the female threaded section.

16. The method of adjusting a length of a telescoping fishing rod as set forth in claim 10, wherein:
the step of providing a plurality of locking guide frames further comprises providing the second end of each locking guide frame with a male key protrusion and the first end of each locking guide frame with a female key recess or slot; and
wherein the step of engaging the male connection portion of the first locking guide frame with the female connection portion further comprises inserting the second end of the first locking guide frame into the first end of the second locking guide frame until the male key protrusion of the second end of the first locking guide frame engages the female key recess or slot of the first end of the second locking guide frame.

17. A method of assembling a telescopic fishing rod having a plurality of rod sections, each rod section having a proximal end closer to a handle of the fishing rod and a distal end closer to a tip of the fishing rod, the rod sections engaged in a telescoping relationship with one another, comprising the steps of
providing a plurality of locking guide frames, each locking guide frame further comprising;
a generally tubular body with a first end and a second end;
the second end forming a male portion of a connection; and
wherein the male portion connection of a first locking guide frame of a distal rod section is configured to engage one of a distal tip of an adjacent proximal rod section or the first end of a second locking guide frame, the distal tip for the adjacent proximal rod section or the first end of the second locking guide frame further comprising a female portion of the connection;
securing one of the locking guide frames to each rod section with the first end of the locking guide frame secured thereto oriented closer to the distal end of the rod section than the second end of the locking guide frame.

18. A locking guide frame for a telescopic fishing rod having a plurality of rod sections engaged in a telescoping relationship with one another, each rod section having a proximal end closer to a handle of the fishing rod and a distal end closer to a tip of the fishing rod, the locking guide frame comprising:
a generally tubular body with a first end and a second end;
the second end forming a male portion of a connection;
wherein one locking guide frame is secured to each rod section and
wherein the male portion connection of a first locking guide frame of a distal rod section is configured to engage one of the a distal tip of an adjacent proximal rod section or the first end of a second locking guide frame, the distal tip for the adjacent proximal rod section or the first end of the second locking guide frame further comprising a female portion of the connection.
